(19) United States
(12) Patent Application Publication
(10) Pub. No.: US 2023/0363384 A1
(43) Pub. Date: Nov. 16, 2023

(54) ALKALI-TREATED FABRICS/FIBERS/STAPLES WITH ANTIMICROBIAL PROPERTIES

(71) Applicant: Ascend Performance Materials Operations LLC, Houston, TX (US)

(72) Inventors: Wai-shing Yung, Houston, TX (US); Rohit Kankaliya, Houston, TX (US); Juan P. Toro, Houston, TX (US)

(73) Assignee: Ascend Performance Materials Operations LLC, Houston, TX (US)

(21) Appl. No.: 18/315,160

(22) Filed: May 10, 2023

Related U.S. Application Data
(60) Provisional application No. 63/340,315, filed on May 10, 2022.

(51) Int. Cl. A01N 25/34; A01N 25/10; A01N 59/16; A01P 1/00; D06M 16/00; D06M 11/38

(52) U.S. Cl. CPC A01N 25/34; A01N 25/10; A01N 59/16; A01P 1/00; D06M 16/00; D06M 11/38; D06M 2101/34

(57) ABSTRACT

This disclosure relates to a process for producing treated AM/AV fibers comprising treating, with an alkali composition, base AM/AV fibers comprising a polymer composition comprising a polymer and an AM/AV compound to form treated AM/AV fibers. The treated AM/AV fibers demonstrate a Klebsiella pneumonia log reduction greater than 1.5, as determined via ISO20743:2013.

### CROSS-REFERENCE

This application is related to and claims priority to U.S. Provisional Patent Application No. 63/340,315 filed May 10, 2022, which is incorporated herein by reference.

### FIELD

The present disclosure relates to antimicrobial fabrics/fibers/staples having improved antimicrobial efficacy.

### BACKGROUND

Conventional base fabrics/fibers/staples have always faced appearance-related problems. Exemplary problems include unswelled fibers, poor dye uptake, and poor luster. The appearance of fabrics is obviously an important factor in the applications for which the fabrics are employed, e.g., clothing. As a result, many efforts have been made to treat the base fabrics to improve the appearance-related features thereof.

One such treatment is the alkali treatment of the base fabrics, which is known in the industry as “mercerizing.” This process removes convolutions from the (cotton) fiber structure and swells the fibers of the fabric, e.g., makes the fibers more round, which improves the hand feel of the fabric and makes it appear more lustrous. In cotton based fabric, mercerizing is known to improve the mechanical strength of the fabric as well.

US Publication No. 20140308865A1 discloses a core spun yarn, wherein the core is a stretchable filament and is surrounded by a sheath of polytrimethylene terephthalate based staple fibers in combination with a second staple fiber. A fabric is made using the core spun yarn. The fabric produced from the core spun yarn is highly stretchable, has high dimensional stability, low growth and high recovery.

U.S. Pat. No. 9,982,372 B2 discloses an article including a woven fabric comprising warp yarns and weft yarns, wherein at least one of either the warp yarns or the weft yarns includes: (a) a corespun elastic base yarn having a denier and including staple fiber and an elastic fiber core; and (b) a separate control yarn selected from the group consisting of a single filament yarn, a multiple filament yarn, a composite yarn, and combinations thereof; having a denier greater than zero to about 0.8 times the denier of the corespun elastic base yarn; wherein the woven fabric includes (1) a ratio of corespun base yarn ends to control yarn ends of up to about 6:1; or (2) a ratio of corespun base yarn picks to control yarn picks of up to about 6:1; or (3) both a ratio of corespun base yarn ends to control yarn ends of up to about 6:1; and a ratio of corespun base yarn picks to control yarn picks of up to about 6:1.

In addition, polymer compositions (and fabrics made therefrom) are disclosed. Such compositions often comprise a polymer and an AM/AV compound. For example, US Publication No. 20210277234A1 discloses a polymer composition having antimicrobial properties, the composition comprising from 50 wt % to 99.99 wt % of a polymer, from 10 wppm to 900 wppm of zinc, less than 1000 wppm of phosphorus, and less than 10 wppm coupling agent and/or surfactant, wherein zinc is dispersed within the polymer; and wherein fibers formed from the polymer composition demonstrate a Klebsiella pneumonia log reduction greater than 0.90, as determined via ISO20743:2013 and/or an Escherichia coli log reduction greater than 1.5, as determined via ASTM E3160 (2018).

Even in view of these references, the need exists for a process that produces compositions/fibers/fabrics that have improved AM/AV efficacy, preferably wherein the improvements are a result of process parameters and wherein the use of additional AM/AV compounds is avoided.

### SUMMARY

In some cases, the present disclosure relates to a process for producing improved, treated AM/AV fibers comprising treating base fibers, e.g., base AM/AV fibers, with an alkali composition, e.g., mercerizing, to form the improved AM/AV fibers. The base fibers optionally comprise a polymer composition comprising a polymer, e.g., a polyamide such as PA6, PA 6,6, PA 6,10, or PA 6,12, or combinations thereof, and an AM/AV compound, and may be staple fibers. The treating may comprise treating the base AM/AV fibers to form the treated AM/AV fibers and treating companion fibers to form treated companion fibers. The companion fibers may comprise a different polymer composition comprising a different polymer, e.g., a natural fiber, preferably cotton and/or cellulose. The improved AM/AV fibers may comprise a polyamide polymer matrix embedded with ionic zinc (Zn²⁺). The improved AM/AV fibers may demonstrate a Klebsiella pneumonia log reduction greater than 1.5, as determined via ISO20743:2013 and/or an Escherichia coli log reduction greater than 1.5, as determined via ASTM E3160 (2018) and/or a Staph Aureus log reduction greater than 3.0, as determined via ISO20743:2013. The treatment may improve the AM/AV performance of the fibers versus that of the base fibers and may comprise contacting the base fibers with an alkali solution with a concentration ranging from 5% to 50% optionally at a dwell time ranging from 5 seconds to 30 minutes and/or at a temperature ranging from 5° C. to 50° C. The treatment may further comprise the steps of washing and/or neutralization. The polymer composition may comprise from 5 wppm to 20,000 AM/AV compound. The polymer may have a relative viscosity (as measured via the formic acid method) less than 100 and may be hydrophilic and/or hygroscopic, and may be capable of absorbing greater than 1.5 wt % water, based on the total weight of the polymer.

In some cases, the disclosure relates to treated AM/AV fibers comprising a polymer and an AM/AV compound, wherein the treated AM/AV fibers are alkali-treated with an alkali composition, wherein the AM/AV fibers demonstrate a Klebsiella pneumonia log reduction greater than 1.5, as determined via ISO20743:2013. The alkali composition may have a concentration ranging from 5% to 50%. The treated AM/AV fibers may comprise PA6, PA 6,6, PA 6,10, or PA 6,12, or combinations thereof and may have a relative viscosity ranging from 20 to 60, as measured by the formic acid method.

### DETAILED DESCRIPTION

### Introduction

As noted above, it is known to treat a base fabric of cotton fibers with an alkali composition, e.g., mercerization, to improve the appearance-related and/or performance-related features thereof. This process removes convolutions from the (cotton) fiber structure and swells the fibers of the fabric, e.g., makes the fibers more round, which improves the hand feel of the fabric and makes it appear more lustrous. In cotton based fabric, mercerizing is known to improve the mechanical strength of the fabric as well. AM/AV compositions/fibers/fabrics are also known. However, there is little or no disclosure in references that teaches that alkali treatment, e.g., mercerization, of a base fabric/fiber (comprising an AM/AV compound) would have any effect on AM/AV efficacy.

It has now been found that treatment of base fabric/fibers comprising an AM/AV compound with an alkali composition surprisingly provides for significant improvements in AM/AV efficacy. This is particularly surprising because, the references are silent on the ability of mercerization to improve such performance. Stated another way, mercerization is not known to improve AM/AV efficacy and there is little or no teaching that conventional mercerization processes employ fabrics that comprise AM/AV compounds. And because mercerized fabrics typically do not contain AM/AV compounds, e.g., zinc compounds, there is no teaching that such improvements would be inherent in existing processes. Importantly, mercerization is employed to address an entirely different set of problems, e.g., unswelled fibers, poor dye uptake, and poor luster properties. When employing the processes describes herein, unexpected improvements in AM/AV efficacy are achieved, in some cases without the need for employing additional (or higher amounts of) AM/AV compounds, which may add cost and other complications to the production process.

### Process for Producing Improved AM/AV Fibers/Fabrics

The present disclosure relates to a process for producing improved AM/AV fibers (or fabrics comprising such fibers). The process comprises the step of treating, with an alkali composition, base fibers or a base fabric to form the improved AM/AV fibers/fabric, which have improved AM/AV efficacy (as compared to that of the base fibers/fabric). The base fibers/fabric comprise (or are made of) an AM/AV polymer composition. Importantly, the AM/AV compound is present in the base fibers/fabric prior to the alkali treatment. For example the AM/AV fibers may demonstrate a Klebsiella pneumonia log reduction greater than 1.5, as determined via ISO20743:2013 and/or an Escherichia coli log reduction greater than 1.5, as determined via ASTM E3160 (2018) and/or a Staph Aureus log reduction greater than 3.0, as determined via ISO20743:2013

The treatment may be a mercerization, which is a treatment that was invented by John Mercer in 1844 and is well-known in the industry. In some cases, the alkali treatment, e.g., the mercerization contributes to or provides for the improved AM/AV performance. In some cases, the process may further comprise the steps of washing and/or neutralization after the alkali treatment.

The fabric (or yarn that makes up the fabric) may comprise base fibers, and in some cases, may comprise multiple types of fibers (see discussion below regarding types of polymers). In some cases, the fabric may comprise polyamide fibers and may further comprises a companion fiber, e.g., cotton. The base fibers and the companion fibers may both be alkali-treated, e.g., to form treated AM/AV fibers and treated companion fibers. Additional materials for companion fibers are disclosed herein.

In some cases, the base fibers comprise AM/AV fibers comprising the AM/AV compound (and optionally polyamide) and companion fibers comprising a different polymer or fiber, e.g., a natural fiber, preferably cotton and/or cellulose (and optionally comprising little or no AM/AV compound).

In some cases, the fabric (or yarn) comprises all polymer, e.g., all nylon, and no companion fiber, e.g., no cotton.

In some cases, the fabric (or yarn) comprises less than 99 wt % AM/AV base fibers, e.g., less than 90 wt %, less than 80 wt %, less than 70 wt %, less than 60 wt %, less than 50 wt %, less than 40 wt %, less than 30 wt %, less than 20 wt %, less than 10 wt %, or less than 5 wt %. In some cases, the fabric (or yarn) comprises greater than 0.1 wt % AM/AV base fibers, e.g., greater than 0.5 wt %, greater than 1 wt %, greater than 5 wt %, greater than 10 wt %, greater than 20 wt %, greater than 30 wt %, greater than 40 wt %, greater than 50 wt %, greater than 60 wt %, greater than 70 wt %, greater than 80 wt %, greater than 90 wt %, or greater than 95 wt %.

In some cases, the fabric (or yarn) comprises less than 99 wt % companion fibers, e.g., less than 90 wt %, less than 80 wt %, less than 70 wt %, less than 60 wt %, less than 50 wt %, less than 40 wt %, less than 30 wt %, less than 20 wt %, less than 10 wt %, or less than 5 wt %. In some cases, the fabric (or yarn) comprises greater than 0.1 wt % companion fibers, e.g., greater than 0.5 wt %, greater than 1 wt %, greater than 5 wt %, greater than 10 wt %, greater than 20 wt %, greater than 30 wt %, greater than 40 wt %, greater than 50 wt %, greater than 60 wt %, greater than 70 wt %, greater than 80 wt %, greater than 90 wt %, or greater than 95 wt %.

The alkali (or basic) treatment may vary widely. In some cases, the treatment comprises contacting the base fibers with an alkali solution at a dwell time and/or at a temperature. In some embodiments, the concentration of the alkali solution ranges from 5% to 50%, e.g., from 10% to 40%, from 15% to 35%, from 20% to 30%, from 22% to 28%, or from 24% to 26%. In terms of lower limits, the concentration of the alkali solution may be greater than 5%, e.g., greater than 10%, greater than 15%, greater than 20%, greater than 22%, or greater than 24%. In terms of upper limits, the concentration of the alkali solution may be less than 50%, e.g., less than 40%, less than 35%, less than 30%, less than 28%, or less than 26%. The alkali solution may comprise and alkali component and a solvent. The alkali component may vary widely and many alkali components are known. Examples include hydroxides, e.g., sodium hydroxide or lithium hydroxide. Alkali component may also be interpreted to include carbonates, ammonia, and other basic compounds that are well known in the art. While these are may not comprise hydroxide ions, these are still contemplated for use in the disclosed process. The alkali solution may be prepared by dissolving the alkali component in the solvent at the stoichiometry suitable to yield the desired concentration.

In some embodiments the treatment is conducted at a dwell time ranging from 5 seconds to 30 minutes, e.g., from 10 seconds to 25 minutes, from 10 seconds to 10 minutes, from 20 seconds to 20 minutes, from 30 seconds to 15 minutes, from 30 seconds to 10 minutes, or from 45 seconds to 5 minutes. In terms of lower limits, the treatment may be conducted at a dwell time greater than 5 seconds, e.g., greater than 10 seconds, greater than 20 seconds, greater than 30 seconds, greater than 45 seconds, greater than 1 minute, greater than 2 minutes, greater than 3 minutes, or greater than 5 minutes. In terms of upper limits, the treatment may be conducted at a dwell time less than 30 minutes, e.g., less than 25 minutes, less than 20 minutes, less than 15 minutes, less than 10 minutes, less than 8 minutes, less than 5 minutes, less than 3 minutes, or less than 2 minutes.

In some embodiments, the treatment is conducted at a temperature ranging from 5° C. to 50° C., e.g., from 5° C. to 40° C., from 8° C. to 30° C., from 10° C. to 25° C., or from 15° C. to 18° C. In terms of lower limits, the treatment may be conducted at a temperature greater than 5° C., e.g., greater than 8° C., greater than 10° C., greater than 12° C., or greater than 15° C. In terms of upper limits, the treatment may be conducted at a temperature less than 50° C., e.g., less than 40° C., less than 30° C., less than 25° C., or less than 18° C.

In some cases, base fibers may be formed into the base fabric or the base material. The base fabric/fibers/materials may comprise (or may be made from) an AM/AV polymer composition that comprises a polymer and an AM/AV compound, e.g., zinc. These components are discussed in more detail herein. The manner of how the fibers are formed may vary widely. Exemplary fiber formation methods include but are not limited to melt spinning, spunbonding, spun lace, melt blowing, electrospinning, and ring spinning. Likewise the manner of how the fabrics are formed may vary widely. Exemplary fabric formation methods include but are not limited to nonwoven production methods and woven production methods such as weaving, knitting. In some embodiments these methods of forming do not affect the positive impact of the alkali treatment on AM/AV performance.

The overall composition of the fabric may vary widely. In some cases the fabric comprises some fibers that comprise an AM/AV compound (optionally employing a polyamide) or are made from an AM/AV composition (optionally employing a polyamide). The fabric may, in some embodiments, also comprise a companion yarn such as cotton, spandex, PET, acrylic, etc.

The description also contemplates other AM/AV compositions/configurations that may be treated to improve AM/AV performance. Examples include wet-wipes, absorbent materials, and feminine hygiene products.

Further, the use of the AM/AV compositions has been shown to increase overall hydrophilicity and/or hygroscopy of the AM/AV materials. For example, it is theorized that a polymer of increased hydrophilicity and/or hygroscopy both may better attract liquid and/or capture media that carry microbials and/or viruses, and may also absorb more moisture, e.g., from the air, and that the increased moisture content allows the polymer composition and the AM/AV compound to more readily destroy, limit, reduce, or inhibit infection and/or pathogenesis of a microbe or virus.

The disclosed improved AM/AV fabrics may provide comfort to the user, for example due to the softness or formability thereof, e.g., due to the characteristics of the fabric sheet such as fiber diameter or denier or to the synergistic properties imparted by the alkali treatment, which may provide the softness. The fabrics may be constructed of AM/AV fibers and/or fabrics, and as such, may impart AM/AV capabilities thereto. As a result, the fabric sheet may prevent transmission of pathogens from contact that otherwise would allow the pathogen to spread or to pass through the material to the wearer.

In some embodiments, the fabric comprises a plurality of fibers having an average fiber diameter less than 50 microns, e.g., less than 45 microns, less than 40 microns, less than 35 microns, less than 30 microns, less than 25 microns, less than 20 microns, less than 15 microns, less than 10 microns, or less than 5 microns. In terms of lower limits, the plurality of fibers may have an average fiber diameter greater than 1 micron, e.g., greater than 1.5 microns, greater than 2 microns, greater than 2.5 microns, greater than 5 microns, or greater than 10 microns. In terms of ranges, the plurality of fibers may have an average fiber diameter from 1 micron to 50 microns, e.g., from 1 micron to 45 microns, from 1 micron to 40 microns, from 1 micron to 35 microns, from 1 micron to 30 microns, from 1 micron to 20 microns, from 1 micron to 15 microns, from 1 micron to 10 microns, from 1 micron to 5 microns, from 1.5 microns to 25 microns, from 1.5 microns to 20 microns, from 1.5 microns to 15 microns, from 1.5 microns to 10 microns, from 1.5 microns to 5 microns, from 2 microns to 25 microns, from 2 microns to 20 microns, from 2 microns to 15 microns, from 2 microns to 10 microns, from 2 microns to 5 microns, from 2.5 microns to 25 microns, from 2.5 microns to 20 microns, from 2.5 microns to 15 microns, from 2.5 microns to 10 microns, from 2.5 microns to 5 microns, from 5 microns to 45 microns, from 5 microns to 40 microns, from 5 microns to 35 microns, from 5 microns to 30 microns, from 10 microns to 45 microns, from 10 microns to 40 microns, from 10 microns to 35 microns, from 10 microns to 30 microns. In some cases, fibers of this size may be referred to as microfibers.

In some embodiments, the fabric comprises a plurality of fibers having an average fiber diameter less than 1 micron, e.g., less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.03 microns. In terms of lower limits, the average fiber diameter of the plurality of fibers may be greater than 1 nanometer, e.g., greater than 10 nanometers, greater than 25 nanometers, or greater than 50 nanometers. In terms of ranges, the average fiber diameter of the plurality of fibers may be from 1 nanometer to 1 micron, e.g., from 1 nanometer to 0.9 microns, from 1 nanometer to 0.8 microns, from 1 nanometer to 0.7 microns, from 1 nanometer to 0.6 microns, from 1 nanometer to 0.5 microns, from 1 nanometer to 0.4 microns, from 1 nanometer to 0.3 microns, from 1 nanometer to 0.2 microns, from 1 nanometer to 0.1 microns, from 1 nanometer to 0.05 microns, from 1 nanometer to 0.04 microns, from 1 nanometer to 0.3 microns, from 10 nanometers to 1 micron, from 10 nanometers to 0.9 microns, from 10 nanometers to 0.8 microns, from 10 nanometers to 0.7 microns, from 10 nanometers to 0.6 microns, from 10 nanometers to 0.5 microns, from 10 nanometers to 0.4 microns, from 10 nanometers to 0.3 microns, from 10 nanometers to 0.2 microns, from 10 nanometers to 0.1 microns, from 10 nanometers to 0.05 microns, from 10 nanometers to 0.04 microns, from 10 nanometers to 0.03 microns, from 25 nanometers to 1 micron, from 25 nanometers to 0.9 microns, from 25 nanometers to 0.8 microns, from 25 nanometers to 0.7 microns, from 25 nanometers to 0.6 microns, from 25 nanometers to 0.5 microns, from 25 nanometers to 0.4 microns, from 25 nanometers to 0.3 microns, from 25 nanometers to 0.2 microns, from 25 nanometers to 0.1 microns, from 25 nanometers to 0.05 microns, from 25 nanometers to 0.04 microns, from 25 nanometers to 0.03 microns, from 50 nanometers to 1 micron, from 50 nanometers to 0.9 microns, from 50 nanometers to 0.8 microns, from 50 nanometers to 0.7 microns, from 50 nanometers to 0.6 microns, from 50 nanometers to 0.5 microns, from 50 nanometers to 0.4 microns, from 50 nanometers to 0.3 microns, from 50 nanometers to 0.2 microns, from 50 nanometers to 0.1 microns, from 50 nanometers to 0.05 microns, from 50 nanometers to 0.04 microns, or from 50 nanometers to 0.03 microns. In some cases, fibers of this size may be referred to as nanofibers.

In some cases, the fabric has a thickness ranging from 25 microns to 500 microns, e.g., from 25 microns to 400 microns, from 35 microns to 300 microns, or from 50 microns to 275 microns. In terms of upper limits, the fabric sheet may have a thickness less than 500 microns, e.g., less than 400 microns, less than 300 microns, or less than 275 microns. In terms of lower limits, the fabric may have a thickness greater than 25 microns, e.g., greater than 35 microns, greater than 50 microns, or greater than 60 microns.

It has been found that the fabric may advantageously be composed of a relatively hydrophilic and/or hygroscopic material. A polymer of increased hydrophilicity and/or hygroscopy may better attract and hold moisture to which to the AM/AV material is exposed. As discussed below, improved, e.g., increased, hydrophilicity and/or hygroscopy may be accomplished by utilizing the polymer compositions described herein. Thus, it is particularly beneficial to form the fabric sheet, e.g., the fibers, from a disclosed polymer composition.

### Physical Characteristics

As noted, each layer of the improved AM/AV fibers/fabric may benefit from increased hydrophilicity and/or hygroscopy.

In some cases, the hydrophilicity and/or hygroscopy of the improved AM/AV fibers/fabric may be measured by saturation. In some cases, the hydrophilicity and/or hygroscopy of a given layer of the improved AM/AV fibers/fabric may be measured by the amount of water it can absorb (as a percentage of total weight). In some embodiments, the layer is capable of absorbing greater than 1.5 wt. % water, based on the total weight of the polymer, e.g., greater than 2.0 wt. %, greater than 3.0%, greater than 5.0 wt. %, greater than 7.0 wt. %, greater than 10.0 wt. %. or greater than 25.0 wt. %. In terms of ranges, the hydrophilic and/or hygroscopic polymer may be capable of absorbing water in an amount ranging from 1.5 wt. % to 50.0 wt. %, e.g., from 1.5 wt. % to 14.0 wt. %, from 1.5 wt. % to 9.0 wt. %, from 2.0 wt. % to 8 wt. %, from 2.0 wt. % to 7 w %, from 2.5 wt. % to 7 wt. %, or from 1.5 wt. % to 25.0 wt. %.

In some cases, the hydrophilicity and/or the hygroscopy of the improved AM/AV fibers/fabric may be measured by the water contact angle of the layer. The water contact angle is the angle formed by the interface of a surface of the layer, e.g., of the fabric.

In some embodiments, the improved AM/AV fibers/fabric demonstrates a water contact angle less than 90°, e.g., less than 85°, less than 80°, or less than 75°. In terms of lower limits, the water contact angle of a layer may be greater than 10°, e.g., greater than 20°, greater than 30°, or greater than 40°. In terms of ranges, the water contact angle of a layer may be from 10° to 90°, e.g., from 10° to 85°, from 10° to 80°, from 10° to 75°, from 20° to 90°, from 20° to 85°, from 20° to 80°, from 20° to 75°, from 30° to 90°, from 30° to 85°, from 30° to 80°, from 30° to 75°, from 40° to 90°, from 40° to 85°, from 40° to 80°, or from 40° to 75°.

The improved AM/AV fibers/fabric of the present disclosure advantageously provide AM/AV properties, e.g., pathogen-destroying properties. For example, the disclosed improved AM/AV fibers/fabric destroy pathogens via contact therewith before the pathogens have a chance to enter or contact the body. The AM/AV properties are made possible, at least in part, by the composition of the fibers that make up the layers. At least one of the layers contains a polymer component along with an AM/AV compound, e.g., zinc and/or copper, which in some cases, is embedded in the polymer structure (but may not be a component of a polymerized co-polymer) along with the alkali treatment. The presence of the AM/AV compound in the polymers of the fibers along with the alkali treatment provides for the pathogen-destroying properties. As a result, the disclosed items prevent growth or transmission of pathogens from contact that otherwise would allow the pathogen to spread. Importantly, because the AM/AV compound may be embedded in the polymer structure, the AM/AV properties are durable, and are not easily worn or washed away. Thus, the improved AM/AV fibers/fabric disclosed herein achieve a synergistic combination of AM/AV efficacy and biocompatibility, e.g. irritation and sensitization, performance.

In some cases the base fibers are staple fibers. In other cases, filaments are also contemplated, and the process may be employed to treat a base filament in the same manner as the base fibers/fabric are treated.

In some cases, a blend of polyamide staple and cotton staple is contemplated.

As noted, the increased hydrophilicity and/or hygroscopy of improved AM/AV fibers/fabric may be the result of a polymer composition from which the layer is formed. The polymer compositions described herein, for example, demonstrate increased hydrophilicity and/or hygroscopy and are therefore particularly suitable for the disclosed improved AM/AV fibers/fabric.

In some embodiments, a polymer may be specially prepared to impart increased hydrophilicity and/or hygroscopy. For example, an increase in hygroscopy may be achieved in the selection and/or modification the polymer. In some embodiments, the polymer may be a common polymer, e.g., a common polyamide, which has been modified to increase hygroscopy. In these embodiments, a functional endgroup modification on the polymer may increase hygroscopy. For example, the polymer may be PA6,6, which has been modified to include a functional endgroup that increases hygroscopy.

### Performance Characteristics

The performance of the improved AM/AV fibers/fabric described herein may be assessed using a variety of conventional metrics.

Antiodor performance may be measured by odor reduction, as measured in accordance with ISO 17299-3 (2014). In some embodiments, the improved AM/AV fibers/fabric demonstrates a odor reduction greater than 50% e.g., greater than 60%, greater than 70%, greater than 80%, or greater than 90%. Odor may be tested using specific test chemicals, e.g., ammonia, acetic acid, isovaleric acid, hydrogen sulfide, indole, and/or nonenal. At least one of the layers (or the fibers thereof) demonstrates the odor reduction for one or more of these test chemicals. The disclosed fabrics may demonstrate an odor reduction greater than 50%, e.g., greater than 60%, greater than 70%, or greater than 80%, as measured in accordance with ISO 17299-3 (2014).

In some cases, the AM/AV performance relates to antifungal performance. The antifungal activity of the improved AM/AV fibers/fabric may be measured by the standard procedure defined by Mod. E3160. In one embodiment, the improved AM/AV fibers/fabric inhibits the growth (growth reduction) of Candida auris or Candida albicans in an amount greater than 10% fungal growth, e.g., greater than 20%, greater than 30%, greater than 40%, greater than 50%, greater than 60%, greater than 70%, greater than 80%, greater than 90% or greater than 93%.

As has been noted, in some embodiments, the improved AM/AV fibers/fabric may demonstrate AM/AV activity. In some cases, the AM/AV activity may be the result of the polymer composition from which the AM/AV materials and the alkali treatment. For example, the AM/AV activity may be the result of forming the improved AM/AV fibers/fabric from a polymer composition described herein and treating it as described herein.

In some embodiments, the improved AM/AV fibers/fabric exhibit permanent, e.g., near permanent, AM/AV properties. Said another way, the AM/AV properties of the polymer composition last for a prolonged period of time, e.g., longer than one or more day, longer than one or more week, longer than one or more month, or longer than one or more years.

The AM/AV properties may include any antimicrobial effect. In some embodiments, for example, the antimicrobial properties of the AM/AV material include limiting, reducing, or inhibiting infection of a microbe, e.g., a bacterium or bacteria. In some embodiments, the antimicrobial properties of the AM/AV material include limiting, reducing, or inhibiting growth and/or killing a bacterium. In some cases, the AM/AV material may limit, reduce, or inhibit both infection and growth of a bacterium.

The bacterium or bacteria affected by the antimicrobial properties of the improved AM/AV fibers/fabric are not particularly limited. In some embodiments, for example, the bacterium is a Streptococcus bacterium (e.g., Streptococcus pneumonia, Streptococcus pyogenes), a Staphylococcus bacterium (e.g., Staphylococcus aureus, Methicillin-resistant Staphylococcus aureus (MRSA)), a Peptostreptococcus bacterium (e.g., Peptostreptococcus anaerobius, Peptostreptococcus asaccharolyticus), a coli bacterium (e.g., Escherichia coli), or a Mycobacterium bacterium, (e.g., Mycobacterium tuberculosis), a Mycoplasma bacterium (e.g., Mycoplasma adleri, Mycoplasma agalactiae, Mycoplasma agassizii, Mycoplasma amphoriforme, Mycoplasma fermentans, Mycoplasma genitalium, Mycoplasma haemofelis, Mycoplasma hominis, Mycoplasma hyopneumoniae, Mycoplasma hyorhinis, Mycoplasma pneumoniae). In some embodiments, the antimicrobial properties include limiting, reducing, or inhibiting the infection or pathogenesis of multiple bacteria, e.g., a combination of two or more bacteria from the above list.

The antimicrobial activity of the improved AM/AV fibers/fabric may be measured by the standard procedure defined by ISO 20743:2013. This procedure measures antimicrobial activity by determining the percentage of a given bacterium or bacteria, e.g. Staphylococcus aureus, inhibited by a tested fiber. In one embodiment, the improved AM/AV fibers/fabric inhibits the growth (growth reduction) of S. aureus in an amount ranging from 60% to 100%, e.g., from 60% to 99.999999%, from 60% to 99.99999%, from 60% to 99.9999%, from 60% to 99.999% from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999%, from 75% to 99%, from 75% to 98%, from 75% to 95%, %, from 80% to 99.999999%, from 80% to 99.99999%, from 80% to 99.9999%, from 80% to 99.999%, from 80% to 100%, from 80% to 99.99%, from 80% to 99.9%, from 80% to 99%, from 80% to 98%, or from 80% to 95%. In terms of lower limits, the improved AM/AV fibers/fabric may inhibit greater than 60% growth of S. aureus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

Klebsiella pneumoniae efficacy may also be determined using the aforementioned tests. In some embodiments, a product formed from the polymer composition inhibits the growth (growth reduction) of Klebsiella pneumoniae, as measured by the test mentioned above. Escherichia coli may be determined using ASTM E3160 (2018). The ranges and limits for Staph Aureus are applicable to Escherichia coli and/or Klebsiella pneumoniae and/or SARS-CoV-2 as well.

Efficacy may be characterized in terms of log reduction. In terms of Escherichia coli log reduction, the improved AM/AV fibers/fabric may be determined via ASTM 3160 (2018) and may demonstrate a E. coli log reduction greater than 1.5, e.g., greater than 2.0, greater than 2.15, greater than 2.5, greater than 2.7, greater than 3.0, greater than 3.3, greater than 4.0, greater than 4.1, greater than 5.0, or greater than 6.0.

In terms of Staph Aureus log reduction, the improved AM/AV fibers/fabric may be determined via ISO 20743:2013 and may demonstrate a microbial log reduction greater than 1.5, e.g., greater than 2.0, greater than 2.5, greater than 2.7, greater than 3.0, greater than 4.0, greater than 5.0, or greater than 6.0.

In terms of Klebsiella pneumoniae log reduction, the improved AM/AV fibers/fabric may be determined via ISO 20743:2013 and may demonstrate a microbial log reduction greater than 1.5, e.g., greater than 2.0, greater than 2.5, greater than 2.6, greater than 3.0, greater than 4.0, greater than 5.0, or greater than 6.0.

In terms of SARS-CoV-2 log reduction, the improved AM/AV fibers/fabric may be determined via ISO 18184:2019 and may demonstrate a viral log reduction greater than 1.5, e.g., greater than 1.7, greater than 2.0, greater than 2.5, greater than 2.6, greater than 3.0, greater than 4.0, greater than 5.0, or greater than 6.0.

The AM/AV properties may include any antiviral effect. In some embodiments, for example, the antiviral properties of the improved AM/AV fibers/fabric include limiting, reducing, or inhibiting infection of a virus. In some embodiments, the antiviral properties of the AM/AV material include limiting, reducing, or inhibiting pathogenesis of a virus. In some cases, the polymer composition may limit, reduce, or inhibit both infection and pathogenesis of a virus.

The virus affected by the antiviral properties of the improved AM/AV fibers/fabric is not particularly limited. In some embodiments, for example, the virus is an adenovirus, a herpesvirus, an ebolavirus, a poxvirus, a rhinovirus, a coxsackievirus, an arterivirus, an enterovirus, a morbillivirus, a coronavirus, an influenza A virus, an avian influenza virus, a swine-origin influenza virus, or an equine influence virus. In some embodiments, the antiviral properties include limiting, reducing, or inhibiting the infection or pathogenesis of one of virus, e.g., a virus from the above list. In some embodiments, the antiviral properties include limiting, reducing, or inhibiting the infection or pathogenesis of multiple viruses, e.g., a combination of two or more viruses from the above list.

In some cases, the virus is a coronavirus, e.g., severe acute respiratory syndrome coronavirus (SARS-CoV), Middle East respiratory syndrome coronavirus (MERS-CoV), or severe acute respiratory syndrome coronavirus 2 (SARS-CoV-2) (e.g., the coronavirus that causes COVID-19). In some cases, the virus is structurally related to a coronavirus.

In some cases, the virus is an influenza virus, such as an influenza A virus, an influenza B virus, an influenza C virus, or an influenza D virus, or a structurally related virus. In some cases, the virus is identified by an influenza A virus subtype, e.g., H1N1, H1N2, H2N2, H2N3, H3N1, H3N2, H3N8, H5N1, H5N2, H5N3, H5N6, H5N8, H5N9, H6N1, H7N1, H7N4, H7N7, H7N9, H9N2, or H10N7.

In some cases, the virus is a bacteriophage, such as a linear or circular single-stranded DNA virus (e.g., phi X 174 (sometimes referred to as ΦX174)), a linear or circular double-stranded DNA, a linear or circular single-stranded RNA, or a linear or circular double-stranded RNA. In some cases, the antiviral properties of the polymer composition may be measured by testing using a bacteriophage, e.g., phi X 174.

In some cases, the virus is an ebolavirus, e.g., Bundibugyo ebolavirus (BDBV), Reston ebolavirus (RESTV), Sudan ebolavirus (SUDV), Taï Forest ebolavirus (TAFV), or Zaire ebolavirus (EBOV). In some cases, the virus is structurally related to an ebolavirus.

The antiviral activity may be measured by a variety of conventional methods. For example, ISO 18184:2019 may be utilized to assess the antiviral activity. In one embodiment, the improved AM/AV fibers/fabric inhibits the pathogenesis (e.g., growth) of a virus in an amount ranging from 60% to 100%, e.g., from 60% to 99.999999%, from 60% to 99.99999%, from 60% to 99.9999%, from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999%, from 75% to 99%, from 75% to 98%, from 75% to 95%, %, from 80% to 99.999999%, from 80% to 99.99999%, from 80% to 99.9999%, from 80% to 99.999%, from 80% to 100%, from 80% to 99.99%, from 80% to 99.9%, from 80% to 99%, from 80% to 98%, or from 80% to 95%. In terms of lower limits, the improved AM/AV fibers/fabric may inhibit greater than 60% of pathogenesis of the virus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

In addition, the use of the polymer compositions disclosed herein provides for biocompatibility advantages. For example, the overall softness of the aforementioned fabrics, along with the compositional characteristics, provides for unexpected reductions in irritation and sensitivity. Beneficially, the disclosed fibers and fabric do not demonstrate the biocompatibility issues associated with conventional fabrics, e.g., those that employ metals with toxicity problems such as silver. For example, the AM/AV polymer compositions demonstrate passing results with regard to irritation and sensitization, as tested in accordance with ISO 10993-10 and 10993-12.

### AM/AV Polymer Composition

As noted above, the AM/AV materials of the present disclosure may comprise polymer compositions that beneficially exhibit antimicrobial and/or antiviral properties. For example, the fabric sheet may be made from and/or may comprise an antimicrobial/antiviral polymer composition as described herein.

AM/AV polymer compositions suitable for use in the AM/AV materials described herein generally comprise a polymer and one or more AM/AV compounds, e.g., metals (e.g., metallic compounds). In some embodiments, the polymer compositions comprise a polymer, zinc (provided to the composition via a zinc compound), and/or phosphorus (provided to the composition via a phosphorus compound). In some embodiments, the polymer compositions comprise a polymer, copper (provided to the composition via a copper compound), and phosphorus (provided to the composition via a phosphorus compound).

Exemplary polymer compositions are disclosed in U.S. patent application Ser. No. 17/192,491, filed Mar. 4, 2021, and U.S. patent application Ser. No. 17/192,533, filed on Mar. 4, 2021, both of which are incorporated herein by reference.

### Polymer

The polymer compositions comprise a polymer, which, in some embodiments, is a polymer suitable for producing fibers and fabrics. In one embodiment, the polymer composition comprises a polymer in an amount ranging from 50 wt. % to 100 wt. %, e.g., from 50 wt. % to 99.99 wt. %, from 50 wt. % to 99.9 wt. %, from 50 wt. % to 99 wt. % from 55 wt. % to 100 wt. %, from 55 wt. % to 99.99 wt. %, from 55 wt. % to 99.9 wt. %, from 55 wt. % to 99 wt. %, from 60 wt. % to 100 wt. %, from 60 wt. % to 99.99 wt. %, from 60 wt. % to 99.9 wt. %, from 60 wt. % to 99 wt. %., from 65 wt. % to 100 wt. %, from 65 wt. % to 99.99 wt. %, from 65 wt. % to 99.9 wt. %, or from 65 wt. % to 99 wt. %. In terms of upper limits, the polymer composition may comprise less than 100 wt. % of the polymer, e.g., less than 99.99 wt. %, less than 99.9 wt. %, or less than 99 wt. %. In terms of lower limits, the polymer composition may comprise greater than 50 wt. % of the polymer, e.g., greater than 55 wt. %, greater than 60 wt. %, or greater than 65 wt. %.

The polymer of the polymer composition may vary widely. The polymer may include but is not limited to, a thermoplastic polymer, polyester, nylon, rayon, polyamide 6, polyamide 6,6, polyethylene (PE), polypropylene (PP), polyethylene terephthalate (PET), polyethylene terephthalate glycol (PETG), co-PET, polybutylene terephthalate (PBT) polylactic acid (PLA), and polytrimethylene terephthalate (PTT). In some embodiments, the polymer composition may comprise PET, for its strength, longevity during washing, ability to be made permanent press, and ability to be blended with other fibers. In some embodiments, the polymer may be PA6,6. In some cases, nylon is known to be a stronger fiber than PET and exhibits a non-drip burning characteristic that is beneficial, e.g., in military or automotive textile applications, and is more hydrophilic than PET. The polymer used in the present disclosure can be a polyamide, polyether amide, polyether ester or polyether urethane or a mixture thereof.

In some cases, the polymer compositions may comprise polyethylene. Suitable examples of polyethylene include linear low-density polyethylene (LLDPE), low-density polyethylene (LDPE), medium-density polyethylene (MDPE), high-density polyethylene (HDPE), and ultra-high-molecular-weight polyethylene (UHMWPE).

In some cases, the polymer compositions may comprise polycarbonate (PC). For example, the polymer composition may comprise a blend of polycarbonate with other polymers, e.g., a blend of polycarbonate and acrylonitrile butadiene styrene (PC-ABS), a blend of polycarbonate and polyvinyl toluene (PC-PVT), a blend of polycarbonate and polybutylene terephthalate (PC-PBT), a blend of polycarbonate and polyethylene terephthalate (PC-PET), or combinations thereof.

In some cases, the polymer composition may comprise polyamides. Common polyamides include nylons and aramids. For example, the polyamide may comprise PA-4T/4I; PA-4T/6I; PA-5T/5I; PA-6; PA6,6; PA6,6/6; PA6,6/6T; PA-6T/6I; PA-6T/6I/6; PA-6T/6; PA-6T/6I/66; PA-6T/MPMDT (where MPMDT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/6I/6; PA-6T/61/12; and copolymers, blends, mixtures and/or other combinations thereof. Additional suitable polyamides, additives, and other components are disclosed in U.S. patent application Ser. No. 16/003,528. In some cases, the polymer comprises PA6, or PA 6,6, or combinations thereof.

In some embodiments, the polymer compositions comprise a thermoplastic polymer, polyester, nylon, rayon, polyamide, polyamide, poly olefin, polyolefin terephthalate, polyolefin terephthalate glycol, co-PET, or polylactic acid, or combinations thereof.

In other embodiments, the polymer composition is blended with an absorbent fiber, such as rayon, lyocell, and/or a natural fiber, such as cotton or hemp. For instance, the polymer composition may be PA-66 blended with rayon or lyocell.

The polymer composition may, in some embodiments, comprise a combination of polyamides. By combining various polyamides, the final composition may be able to incorporate the desirable properties, e.g., mechanical properties, of each constituent polyamides. For example, in some embodiments, the polyamide comprises a combination of PA-6, PA6,6, and PA6,6/6T. In these embodiments, the polyamide may comprise from 1 wt. % to 99 wt. % PA-6, from 30 wt. % to 99 wt. % PA6,6, and from 1 wt. % to 99 wt. % PA6,6/6T. In some embodiments, the polyamide comprises one or more of PA-6, PA6,6, and PA6,6/6T. In some aspects, the polymer composition comprises 6 wt. % of PA-6 and 94 wt. % of PA6,6. In some aspects, the polymer composition comprises copolymers or blends of any of the polyamides mentioned herein.

The polymer composition may also comprise polyamides produced through the ring-opening polymerization or polycondensation, including the copolymerization and/or copolycondensation, of lactams. Without being bound by theory, these polyamides may include, for example, those produced from propriolactam, butyrolactam, valerolactam, and caprolactam. For example, in some embodiments, the polyamide is a polymer derived from the polymerization of caprolactam. In those embodiments, the polymer comprises at least 10 wt. % caprolactam, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, or at least 60 wt. %. In some embodiments, the polymer includes from 10 wt. % to 60 wt. % of caprolactam, e.g., from 15 wt. % to 55 wt. %, from 20 wt. % to 50 wt. %, from 25 wt. % to 45 wt. %, or from 30 wt. % to 40 wt. %. In some embodiments, the polymer comprises less than 60 wt. % caprolactam, e.g., less than 55 wt. %, less than 50 wt. %, less than 45 wt. %, less than 40 wt. %, less than 35 wt. %, less than 30 wt. %, less than 25 wt. %, less than 20 wt. %, or less than 15 wt. %. Furthermore, the polymer composition may comprise the polyamides produced through the copolymerization of a lactam with a nylon, for example, the product of the copolymerization of a caprolactam with PA6,6.

In some aspects, the polymer can formed by conventional polymerization of the polymer composition in which an aqueous solution of at least one diamine-carboxylic acid salt is heated to remove water and effect polymerization to form an antiviral nylon. This aqueous solution is preferably a mixture which includes at least one polyamide-forming salt in combination with the specific amounts of a zinc compound, a copper compound, and/or a phosphorus compound described herein to produce a polymer composition. Conventional polyamide salts are formed by reaction of diamines with dicarboxylic acids with the resulting salt providing the monomer. In some embodiments, a preferred polyamide-forming salt is hexamethylenediamine adipate (nylon 6,6 salt) formed by the reaction of equimolar amounts of hexamethylenediamine and adipic acid.

Different polymers may be used to form different fibers, which in turn, form the base fibers as a whole. The base fibers may comprise AM/AV base fibers and companion fibers. The AM/AV base fibers may be made from the AM/AV compositions. The companion fibers may be made from a different polymer composition with or without AM/AV compound.

In some cases, the polymer comprises natural polymer or natural fibers, e.g., cotton or cellulose/wood pulp.

In some embodiments, the polymer excludes natural polymer or natural fiber. For example, the polymer may comprises less than 10 wt % polymer or natural fibers, e.g., less than 5 wt %, less than 3 wt %, less than 1 wt %, less than 0.5 wt %, or less than 0.1 wt %. In some cases, the polymer comprises little or no cotton.

In some embodiments, the polymer comprises a combination of natural and synthetic polymers. For example, the polymer may comprise polyamide and/or cotton and/or cellulose. In some cases, the polymer comprises polyamide and cotton.

### AM/AV (Metallic) Compounds

As noted above, the polymer composition may include one or more AM/AV compounds, which may be in the form of a metallic compound. In some embodiments, the polymer composition includes zinc, e.g., in a zinc compound, optionally phosphorus, e.g., in a phosphorus compound, optionally copper, e.g., in a copper compound, optionally silver, e.g., in a silver compound, or combinations thereof. As used herein, a metallic compound refers to a compound having at least one metal molecule or ion, e.g., a “zinc compound” refers to a compound having at least one zinc molecule or ion.

Some conventional polymer compositions, fibers and fabrics utilize AM/AV compounds to inhibit viruses and other pathogens. For example, some fabrics may include antimicrobial additives, e.g., silver, coated or applied as a film on an exterior surface. However, it has been found that these treatments or coatings often present a host of problems. For example, the coated additives may extract out of the fibers/fabric during dyeing or washing processes, which adversely affects the antimicrobial and/or antiviral properties. As it relates to conventional products, while in constant use, some coatings, e.g., silver, may contribute to health and/or even environmental problems. In contrast to conventional formulations, the polymer compositions disclosed herein comprise a unique combination of AM/AV compounds (e.g., metallic compounds) rather than simply coating the AM/AV compounds on a surface. Stated another way, the polymer composition may have certain amounts of a metallic compound embedded in the polymer matrix such that the polymer composition retains AM/AV properties during and after dyeing and/or washing.

In one embodiment, AM/AV compounds can be added as a masterbatch. The masterbatch may include a polyamide such as nylon 6 or nylon 6,6. Other masterbatch compositions are contemplated.

The polymer composition may comprise metallic compounds, e.g., a metal or a metallic compound, dispersed within the polymer composition. In one embodiment, the polymer composition comprises metallic compounds in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm metallic compounds, e.g., greater than 10 wppm, greater than 50 wppm, greater than 100 wppm, greater than 200 wppm, or greater than 300 wppm. In terms of upper limits, the polymer composition may comprise less than 20,000 wppm metallic compounds, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. As noted above, the metallic compounds are preferably embedded in the polymer formed from the polymer composition.

As noted above, the polymer composition includes zinc in a zinc compound and phosphorus in a phosphorus compound, preferably in specific amounts in the polymer composition, to provide the aforementioned structural and antiviral benefits. As used herein, “zinc compound” refers to a compound having at least one zinc molecule or ion (likewise for copper compounds). As used herein, “phosphorus compound” refers to a compound having at least one phosphorus molecule or ion. Zinc content may be indicated by zinc or zinc ion (the same is true for copper). The ranges and limits may be employed for zinc content and for zinc ion content, and for other metal content, e.g., copper content. The calculation of zinc ion content based on zinc or zinc compound can be made by the skilled chemist, and such calculations and adjustments are contemplated.

The polymer composition may comprise zinc, e.g., in a zinc compound or as zinc ion, e.g., zinc or a zinc compound, dispersed within the polymer composition. In one embodiment, the polymer composition comprises zinc in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, 5000 wppm to 20000 wppm, from 200 wppm to 3000 wppm, from 200 wppm to 2000 wppm, from 200 wppm to 1000 wppm, from 200 wppm to 500 wppm, from 10 wppm to 900 wppm, from 200 wppm to 900 wppm, from 425 wppm to 600 wppm, from 425 wppm to 525 wppm, from 350 wppm to 600 wppm, from 375 wppm to 600 wppm, from 375 wppm to 525 wppm, from 480 wppm to 600 wppm, from 480 wppm to 525 wppm, from 600 wppm to 750 wppm, or from 600 wppm to 700 wppm.

In terms of lower limits, the polymer composition may comprise greater than 5 wppm of zinc, e.g., greater than 10 wppm, greater than 50 wppm, greater than 100 wppm, greater than 200 wppm, greater than 300 wppm, greater than 350 wppm, greater than 375 wppm, greater than 400 wppm, greater than 425 wppm, greater than 480 wppm, greater than 500 wppm, or greater than 600 wppm.

In terms of upper limits, the polymer composition may comprise less than 20,000 wppm of zinc, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, less than 500 wppm, less than 400 wppm, less than 330 wppm, less than 300. In some aspects, the zinc compound is embedded in the polymer formed from the polymer composition.

The ranges and limits are applicable to both zinc in elemental or ionic form and to zinc compound. The same is true for other ranges and limits disclosed herein relating to other metals, e.g., copper. For example, the ranges may relate to the amount of zinc ions dispersed in the polymer.

The zinc of the polymer composition is present in or provided via a zinc compound, which may vary widely. The zinc compound may comprise zinc oxide, zinc ammonium adipate, zinc acetate, zinc ammonium carbonate, zinc stearate, zinc phenyl phosphinic acid, or zinc pyrithione, or combinations thereof. In some embodiments, the zinc compound comprises zinc oxide, zinc ammonium adipate, zinc acetate, or zinc pyrithione, or combinations thereof. In some embodiments, the zinc compound comprises zinc oxide, zinc stearate, or zinc ammonium adipate, or combinations thereof. In some aspects, the zinc is provided in the form of zinc oxide. In some aspects, the zinc is not provided via zinc phenyl phosphinate and/or zinc phenyl phosphonate.

The inventors have also found that the polymer compositions surprisingly may benefit from the use of specific zinc compounds. In particular, the use of zinc compounds prone to forming ionic zinc (e.g., Zn²⁺) may increase the antiviral properties of the polymer composition. It is theorized that the ionic zinc disrupts the replicative cycle of the virus. For example, the ionic zinc may interfere with, e.g., inhibit viral protease or polymerase activity. Further discussion of the effect of ionic zinc on viral activity is found in Velthuis et al., Zn Inhibits Coronavirus and Arterivirus RNA Polymerase Activity In Vitro and Zinc Ionophores Block the Replication of These Viruses in Cell Culture, PLoS Pathogens (November 2010), which is incorporated herein by reference.

The amount of the zinc compound present in the polymer compositions may be discussed in relation to the ionic zinc content. In one embodiment, the polymer composition comprises ionic zinc, e.g., Zn²⁺, in an amount ranging from 1 wppm to 30,000 wppm, e.g., from 1 wppm to 25,000 wppm, from 1 wppm to 20,000 wppm, from 1 wppm to 15,000 wppm, from 1 wppm to 10,000 wppm, from 1 wppm to 5,000 wppm, from 1 wppm to 2,500 wppm, from 50 wppm to 30,000 wppm, from 50 wppm to 25,000 wppm, from 50 wppm to 20,000 wppm, from 50 wppm to 15,000 wppm, from 50 wppm to 10,000 wppm, from 50 wppm to 5,000 wppm, from 50 wppm to 2,500 wppm, from 100 wppm to 30,000 wppm, from 100 wppm to 25,000 wppm, from 100 wppm to 20,000 wppm, from 100 wppm to 15,000 wppm, from 100 wppm to 10,000 wppm, from 100 wppm to 5,000 wppm, from 100 wppm to 2,500 wppm, from 150 wppm to 30,000 wppm, from 150 wppm to 25,000 wppm, from 150 wppm to 20,000 wppm, from 150 wppm to 15,000 wppm, from 150 wppm to 10,000 wppm, from 150 wppm to 5,000 wppm, from 150 wppm to 2,500 wppm, from 250 wppm to 30,000 wppm, from 250 wppm to 25,000 wppm, from 250 wppm to 20,000 wppm, from 250 wppm to 15,000 wppm, from 250 wppm to 10,000 wppm, from 250 wppm to 5,000 wppm, or from 250 wppm to 2,500 wppm. In some cases, the ranges and limits mentioned above for zinc may also be applicable to ionic zinc content.

The zinc may be embedded in the polymer matrix. For example, the fibers may comprise a polyamide polymer matrix embedded with zinc, for instance ionic zinc (Zn²⁺).

In some cases, the use of zinc provides for processing and or end use benefits. Other antiviral agents, e.g., copper or silver, may be used, but these often include adverse effects (e.g., on the relative viscosity of the polymer composition, toxicity, and health or environmental risk). In some situations, the zinc does not have adverse effects on the relative viscosity of the polymer composition. Also, the zinc, unlike other antiviral agents, e.g., silver, does not present toxicity issues (and in fact may provide health advantages, such as immune system support). In addition, as noted herein, the use of zinc provides for the reduction or elimination of leaching into other media and/or into the environment. This both prevents the risks associated with introducing zinc into the environment and allows the polymer composition to be reused—zinc provides surprising “green” advantages over conventional, e.g., silver-containing, compositions.

As noted above, the polymer composition, in some embodiments, includes copper (provided via a copper compound). As used herein, “copper compound” refers to a compound having at least one copper molecule or ion.

In some cases, the copper compound may improve, e.g., enhance the antiviral properties of the polymer composition. In some cases, the copper compound may affect other characteristics of the polymer composition, e.g., antimicrobial activity or physical characteristics.

The polymer composition may comprise copper (e.g., in a copper compound), e.g., copper or a copper compound, dispersed within the polymer composition. In one embodiment, the polymer composition comprises copper in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 5 wppm to 100 wppm, from 5 wppm to 50 wppm, from 5 wppm to 35 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 100 wppm to 400 wppm, from 110 wppm to 350 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm of copper, e.g., greater than 10 wppm, greater than 50 wppm, greater than 100 wppm, greater than 109 wppm, greater than 200 wppm, or greater than 300 wppm. In terms of upper limits, the polymer composition may comprise less than 20,000 wppm of copper, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, less than 500 wppm, less than 350 wppm, less than 100 wppm, less than 50 wppm, less than 35 wppm. In some aspects, the copper compound is embedded in the polymer formed from the polymer composition.

The composition of the copper compound is not particularly limited. Suitable copper compounds include copper iodide, copper bromide, copper chloride, copper fluoride, copper oxide, copper stearate, copper ammonium adipate, copper acetate, or copper pyrithione, or combinations thereof. The copper compound may comprise copper oxide, copper ammonium adipate, copper acetate, copper ammonium carbonate, copper stearate, copper phenyl phosphinic acid, or copper pyrithione, or combinations thereof. In some embodiments, the copper compound comprises copper oxide, copper ammonium adipate, copper acetate, or copper pyrithione, or combinations thereof. In some embodiments, the copper compound comprises copper oxide, copper stearate, or copper ammonium adipate, or combinations thereof. In some aspects, the copper is provided in the form of copper oxide. In some aspects, the copper is not provided via copper phenyl phosphinate and/or copper phenyl phosphonate.

In some cases, the polymer composition includes silver (optionally provided via a silver compound). As used herein, “silver compound” refers to a compound having at least one silver molecule or ion. The silver may be in ionic form. The ranges and limits for silver may be similar to the ranges and limits for copper (discussed above).

In one embodiment, the molar ratio of the copper to the zinc is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the copper to the zinc in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc to copper in the polymer composition may be less than 15:1, e.g., less than 10:1, less than 9:1, less than 8:1, less than 7:1, less than 6:1, less than 5:1, less than 4:1, or less than 3:1. In some cases, copper is bound in the polymer matrix along with zinc.

In some embodiments, the use of cuprous ammonium adipate has been found to be particularly effective in activating copper ions into the polymer matrix. Similarly, the use of silver ammonium adipate has been found to be particularly effective in activating silver ions into the polymer matrix. It is found that dissolving copper (I) or copper (II) compounds in ammonium adipate is particularly efficient at generating copper (I) or copper (II) ions. The same is true for dissolving Ag (I) or Ag (III) compounds in ammonium adipate to generate Ag¹⁺ or Ag³⁺ ions.

The polymer composition may comprise silver (e.g., in a silver compound), e.g., silver or a silver compound, dispersed within the polymer composition. In one embodiment, the polymer composition comprises silver in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm of silver, e.g., greater than 10 wppm, greater than 50 wppm, greater than 100 wppm, greater than 200 wppm, or greater than 300 wppm. In terms of upper limits, the polymer composition may comprise less than 20,000 wppm of silver, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. In some aspects, the silver compound is embedded in the polymer formed from the polymer composition.

The composition of the silver compound is not particularly limited. Suitable silver compounds include silver iodide, silver bromide, silver chloride, silver fluoride, silver oxide, silver stearate, silver ammonium adipate, silver acetate, or silver pyrithione, or combinations thereof. The silver compound may comprise silver oxide, silver ammonium adipate, silver acetate, silver ammonium carbonate, silver stearate, silver phenyl phosphinic acid, or silver pyrithione, or combinations thereof. In some embodiments, the silver compound comprises silver oxide, silver ammonium adipate, silver acetate, or silver pyrithione, or combinations thereof. In some embodiments, the silver compound comprises silver oxide, silver stearate, or silver ammonium adipate, or combinations thereof. In some aspects, the silver is provided in the form of silver oxide. In some aspects, the silver is not provided via silver phenyl phosphinate and/or silver phenyl phosphonate. In some aspects, the silver is provided by dissolving one or more silver compounds in ammonium adipate.

The polymer composition may comprise phosphorus (in a phosphorus compound), e.g., phosphorus or a phosphorus compound is dispersed within the polymer composition. In one embodiment, the polymer composition comprises phosphorus in an amount ranging from 50 wppm to 10000 wppm, e.g., from 50 wppm to 5000 wppm, from 50 wppm to 2500 wppm, from 50 wppm to 2000 wppm, from 50 wppm to 800 wppm, 100 wppm to 750 wppm, 100 wppm to 1800 wppm, from 100 wppm to 10000 wppm, from 100 wppm to 5000 wppm, from 100 wppm to 2500 wppm, from 100 wppm to 1000 wppm, from 100 wppm to 800 wppm, from 200 wppm to 10000 wppm, 200 wppm to 5000 wppm, from 200 wppm to 2500 wppm, from 200 wppm to 800 wppm, from 300 wppm to 10000 wppm, from 300 wppm to 5000 wppm, from 300 wppm to 2500 wppm, from 300 wppm to 500 wppm, from 500 wppm to 10000 wppm, from 500 wppm to 5000 wppm, or from 500 wppm to 2500 wppm. In terms of lower limits, the polymer composition may comprise greater than 50 wppm of phosphorus, e.g., greater than 75 wppm, greater than 100 wppm, greater than 150 wppm, greater than 200 wppm greater than 300 wppm or greater than 500 wppm. In terms of upper limits, the polymer composition may comprise less than 10000 wppm (or 1 wt. %), e.g., less than 5000 wppm, less than 2500 wppm, less than 2000 wppm, less than 1800 wppm, less than 1500 wppm, less than 1000 wppm, less than 800 wppm, less than 750 wppm, less than 500 wppm, less than 475 wppm, less than 450 wppm, less than 400 wppm, less than 350 wppm, less than 300 wppm, less than 250 wppm, less than 200 wppm, less than 150 wppm, less than 100 wppm, less than 50 wppm, less than 25 wppm, or less than 10 wppm.

In some aspects, the phosphorus or the phosphorus compound is embedded in the polymer formed from the polymer composition. As noted above, because of the overall make-up of the disclosed composition low amounts, if any, phosphorus may be employed, which in some cases may provide for advantageous performance results (see above).

The phosphorus of the polymer composition is present in or provided via a phosphorus compound, which may vary widely. The phosphorus compound may comprise bezene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, diphenylrnethyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, and combinations thereof. In some embodiments, the phosphorus compound comprises phosphoric acid, benzene phosphinic acid, or benzene phosphonic acid, or combinations thereof. In some embodiments, the phosphorus compound comprises benzene phosphinic acid, phosphorous acid, or manganese hypophosphite, or combinations thereof. In some aspects, the phosphorus compound may comprise benzene phosphinic acid.

Advantageously, it has been discovered that adding the above identified zinc compounds and optionally phosphorus compounds may result in a beneficial relative viscosity (RV) of the polymer composition. In some embodiments, the RV of the polymer composition ranges from 5 to 100, e.g., from 5 to 80, from 5 to 70, from 10 to 70, from 15 to 65, from 20 to 60, from 30 to 50, from 35 to 45, from 10 to 35, from 10 to 20, from 60 to 70, from 50 to 80, from 40 to 50, from 30 to 60, from 5 to 30, or from 15 to 32. In terms of lower limits, the RV of the polymer composition may be greater than 5, e.g., greater than 10, greater than 15, greater than 20, greater than 25, greater than 27.5, greater than 30, greater than 35, greater than 37.5, greater than 40, or greater than 50. In terms of upper limits, the RV of the polymer composition may be less than 100, e.g., less than 90, less than 80, less than 70, less than 65, less than 60, less than 50, less than 45, less than 42.5, less than 40, or less than 35.

To calculate RV, a polymer is dissolved in a solvent (usually formic or sulfuric acid), the viscosity is measured, then the viscosity is compared to the viscosity of the pure solvent. This give a unitless measurement. Solid materials, as well as liquids, may have a specific RV. The fibers/fabrics produced from the polymer compositions may have the aforementioned relative viscosities, as well.

### ADDITIONAL COMPONENTS

In some embodiments, the polymer composition may comprise additional additives. The additives include pigments, hydrophilic or hydrophobic additives, anti-odor additives, additional antiviral agents, and antimicrobial/anti-fungal inorganic compounds, such as copper, zinc, tin, and silver.

In some embodiments, the polymer composition can be combined with color pigments for coloration for the use in fabrics or other components formed from the polymer composition. In some aspects, the polymer composition can be combined with UV additives to withstand fading and degradation in fabrics exposed to significant UV light. In some aspects, the polymer composition can be combined with additives to make the surface of the fiber hydrophilic or hydrophobic. In some aspects, the polymer composition can be combined with a hygroscopic material, e.g., to make the fiber, fabric, or other products formed therefrom more hygroscopic. In some aspects, the polymer composition can be combined with additives to make the fabric flame retardant or flame resistant. In some aspects, the polymer composition can be combined with additives to make the fabric stain resistant. In some aspects, the polymer composition can be combined with pigments with the antimicrobial compounds so that the need for conventional dyeing and disposal of dye materials is avoided.

In some embodiments, the polymer composition may further comprise additional additives. For example, the polymer composition may comprise a delusterant. A delusterant additive may improve the appearance and/or texture of the synthetic fibers and fabric produced from the polymer composition. In some embodiments, inorganic pigment-like materials can be utilized as delusterants. The delusterants may comprise one or more of titanium dioxide, barium sulfate, barium titanate, zinc titanate, magnesium titanate, calcium titanate, zinc oxide, zinc sulfide, lithopone, zirconium dioxide, calcium sulfate, barium sulfate, aluminum oxide, thorium oxide, magnesium oxide, silicon dioxide, talc, mica, and the like. In preferred embodiments, the delusterant comprises titanium dioxide. It has been found that the polymer compositions that include delusterants comprising titanium dioxide produce synthetic fibers and fabrics that greatly resemble natural fibers and fabrics, e.g., synthetic fibers and fabrics with improved appearance and/or texture. It is believed that titanium dioxide improves appearance and/or texture by interacting with the zinc compound, the phosphorus compound, and/or functional groups within the polymer.

In one embodiment, the polymer composition comprises the delusterant in an amount ranging from 0.0001 wt. % to 3 wt. %, e.g., 0.0001 wt. % to 2 wt. %, from 0.0001 to 1.75 wt. %, from 0.001 wt. % to 3 wt. %, from 0.001 wt. % to 2 wt. %, from 0.001 wt. % to 1.75 wt. %, from 0.002 wt. % to 3 wt. %, from 0.002 wt. % to 2 wt. %, from 0.002 wt. % to 1.75 wt. %, from 0.005 wt. % to 3 wt. %, from 0.005 wt. % to 2 wt. %, from 0.005 wt. % to 1.75 wt. %. In terms of upper limits, the polymer composition may comprise less than 3 wt. % delusterant, e.g., less than 2.5 wt. %, less than 2 wt. % or less than 1.75 wt. %. In terms of lower limits, the polymer composition may comprise greater than 0.0001 wt. % delusterant, e.g., greater than 0.001 wt. %, greater than 0.002 wt. %, or greater than 0.005 wt. %.

In some embodiments, the polymer composition may further comprise colored materials, such as carbon black, copper phthalocyanine pigment, lead chromate, iron oxide, chromium oxide, and ultramarine blue.

In some embodiments, the polymer composition may include additional antiviral agents other than zinc. The additional antimicrobial agents may be any suitable antiviral. Conventional antiviral agents are known in the art and may be incorporated in the polymer composition as the additional antiviral agent or agents. For example, the additional antiviral agent may be an entry inhibitor, a reverse transcriptase inhibitor, a DNA polymerase inhibitor, an m-RNA synthesis inhibitor, a protease inhibitor, an integrase inhibitor, or an immunomodulator, or combinations thereof. In some aspects, the additional antimicrobial agent or agents are added to the polymer composition.

In some embodiments, the polymer composition may include additional antimicrobial agents other than zinc. The additional antimicrobial agents may be any suitable antimicrobial, such as silver, copper, and/or gold in metallic forms (e.g., particulates, alloys and oxides), salts (e.g., sulfates, nitrates, acetates, citrates, and chlorides) and/or in ionic forms. In some aspects, further additives, e.g., additional antimicrobial agents, are added to the polymer composition.

In some embodiments, the polymer composition (and the fibers or fabric formed therefrom) may further comprise an antimicrobial or antiviral coating. For example, a fiber or fabric formed from the polymer composition may include a coating of zinc nanoparticles (e.g., nanoparticles of zinc oxide, zinc ammonium adipate, zinc acetate, zinc ammonium carbonate, zinc stearate, zinc phenyl phosphinic acid, or zinc pyrithione, or combinations thereof). To produce such a coating, the surface of polymer composition (e.g., the surface of the fiber and/or fabric formed therefrom) may be cationized and coated layer-by-layer by stepwise dipping the polymer composition into an anionic polyelectrolyte solution (e.g., comprising poly 4-styrenesulfonic acid) and a solution comprising the zinc nanoparticles. Optionally, the coated polymer composition may be hydrothermally treated in a solution of NH₄OH at 9° C. for 24 h to immobilize the zinc nanoparticles.

In some cases, the AM/AV materials described herein do not require the use or inclusion of acids, e.g., citric acid, and/or acid treatment to be effective. Such treatments are known to create static charge/static decay issues. Advantageously, the elimination of the need for acid treatment, thus eliminates the static charge/static decay issues associated with conventional configurations.

### Metal Retention Rate

As noted, the AM/AV materials described herein have permanent, e.g., near-permanent, antimicrobial and/or antiviral properties. The permanence of these properties allows the AM/AV materials to be reused, e.g., after washing, further extending the usefulness of the article.

One metric for assessing the permanence, e.g., near-permanence, of the antimicrobial and/or antiviral properties of the AM/AV material is metal retention. As discussed above, the AM/AV materials may be prepared from the disclosed polymer compositions, which may include various metallic compounds, e.g., zinc compound, phosphorus, copper compound, and/or silver compound. The metallic compounds of the polymer compositions may provide antimicrobial and/or antiviral properties to the AM/AV material. Thus, retention of the metallic compounds, e.g., after one or more cycles of washing, may provide permanent, e.g., near-permanent, antimicrobial and/or antiviral properties.

Beneficially, AM/AV materials formed from the disclosed polymer compositions demonstrate relatively high metal retention rate. The metal retention rate may relate to the retention rate of a specific metal in the polymer composition, e.g., zinc retention, copper retention, or to the retention rate of all metals in the polymer composition, e.g., total metal retention.

As discussed above, the alkali treatment has been found to mercerization will improve the efficacy of the AM/AV compound such that overall performance is improved. In some cases, when zinc content remains constant or essentially constant, the efficacy is improved. In some cases, when zinc content is reduced, the efficacy is improved.

In some embodiments, the AM/AV materials formed from the disclosed polymer compositions have a metal retention greater than 65% as measured by a dye bath test, e.g., greater than 75%, greater than 80%, greater than 90%, greater than 95%, greater than 97%, greater than 98%, greater than 99%, greater than 99.9%, greater than 99.99%, greater than 99.999%, greater than 99.9999%, greater than 99.99999% or greater than 99.999999%. In terms of upper limits, the AM/AV materials may have a metal retention of less than 100%, e.g., less than 99.9%, less than 98%, or less than 95%. In terms of ranges, the AM/AV materials may have a metal retention may be from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In some cases, the ranges and limits relate to dye recipes having lower pH values, e.g., less than (and/or including) 5.0, less than 4.7, less than 4.6, or less than 4.5. In some cases, the ranges and limits relate to dye recipes having higher pH values, e.g., greater than (and/or including) 4.0, greater than 4.2, greater than 4.5, greater than 4.7, greater than 5.0, or greater than 5.2.

In some embodiments, the AM/AV materials formed from the disclosed polymer compositions have a metal retention greater than 40% after a dye bath, e.g., greater than 44%, greater than 45%, greater than 50%, greater than 55%, greater than 60%, greater than 65%, greater than 70%, greater than 75%, greater than 80%, greater than 90%, greater than 95%, or greater than 99%. In terms of upper limits, the AM/AV materials may have a metal retention of less than 100%, e.g., less than 99.9%, less than 98%, less than 95% or less than 90%. In terms of ranges, the AM/AV materials may have a metal retention in a range from 40% to 100%, e.g., from 45% to 99.9%, from 50% to 99.9%, from 75% to 99.9%, from 80% to 99%, or from 90% to 98%. In some cases, the ranges and limits relate to dye recipes having higher pH values, e.g., greater than (and/or including) 4.0, greater than 4.2, greater than 4.5, greater than 4.7, greater than 5.0, or greater than 5.2. (wsy—same comment for this paragraph. Should we focus on the zinc retention and the pH that would allow higher zinc retention even though the improved AM/AV performance does not seem to be affected by final zinc level.)

In some embodiments, the AM/AV materials formed from the polymer compositions have a metal retention greater than 20%, e.g., greater than 24%, greater than 25%, greater than 30%, greater than 35%, greater than 40%, greater than 45%, greater than 50%, greater than 55%, or greater than 60%. In terms of upper limits, the AM/AV materials may have a metal retention of less than 80%, e.g., less than 77%, less than 75%, less than 70%, less than 68%, or less than 65%. In terms of ranges, the AM/AV materials may have a metal retention ranging from 20% to 80%, e.g., from 25% to 77%, from 30% to 75%, or from 35% to 70%. In some cases, the ranges and limits relate to dye recipes having lower pH values, e.g., less than (and/or including) 5.0, less than 4.7, less than 4.6, or less than 4.5. (wsy—same comment as the one for the previous several sections.)

Stated another way, in some embodiments, the AM/AV materials formed from the polymer composition demonstrate an extraction rate of the metal compound less than 35% as measured by the dye bath test, e.g., less than 25%, less than 20%, less than 10%, or less than 5%. In terms of upper limits, the AM/AV materials may demonstrate an extraction rate of the metal compound greater than 0%, e.g., greater than 0.1%, greater than 2% or greater than 5%. In terms of ranges, the AM/AV materials may demonstrate an extraction rate of the metal compound from 0% to 35%, e.g., from 0% to 25%, from 0% to 20%, from 0% to 10%, from 0% to 5%, from 0.1% to 35%, from 0.1% to 25%, from 0.1% to 20%, from 0.2% to 10%, from 0.1% to 5%, from 2% to 35%, from 2% to 25%, from 2% to 20%, from 2% to 10%, from 2% to 5%, from 5% to 35%, from 5% to 25%, from 5% to 20%, or from 5% to 10%. (wsy—same comment as the one for the previous several sections.)

The metal retention of an AM/AV material may be measured by a dye bath test according to the following standard procedure. A sample is cleaned (all oils are removed) by a scour process. The scour process may employ a heated bath, e.g., conducted at 71° C. for 15 minutes. A scouring solution comprising 0.25% on weight of fiber (“owf”) of Sterox (723 Soap) nonionic surfactant and 0.25% owf of TSP (trisodium phosphate) may be used. The samples are then rinsed with cold water.

The cleaned samples may be tested according a chemical dye level procedure. This procedure may employ placing them in a dye bath comprising 1.0% owf of C.I. Acid Blue 45, 4.0% owf of MSP (monosodium phosphate), and a sufficient % owf of disodium phosphate or TSP to achieve a pH of 6.0, with a 28:1 liquor to sample ratio. For example, if a pH of less than 6 is desired, a 10% solution of the desired acid may be added using an eye dropper until the desired pH was achieved. The dye bath may be preset to bring the bath to a boil at 100° C. The samples are placed in the bath for 1.5 hours. As one example, it may take approximately 30 minutes to reach boil and hold one hour after boil at this temperature. Then the samples are removed from the bath and rinsed. The samples are then transferred to a centrifuge for water extraction. After water extraction, the samples were laid out to air dry. The component amounts are then recorded.

In some embodiments, the metal retention of a fiber formed from the polymer composition may be calculated by measuring metal content before and after a dye bath operation. The amount of metal retained after the dye bath may be measured by known methods. For the dye bath, an Ahiba dyer (from Datacolor) may be employed. In a particular instance, twenty grams of un-dyed fabric and 200 ml of dye liquor may be placed in a stainless steel can, the pH may be adjusted to the desired level, the stainless steel can may be loaded into the dyer; the sample may be heated to 40° C. then heated to 100° C. (optionally at 1.5° C./minute). In some cases a temperature profile may be employed, for example, 1.5° C./minute to 60° C., 1° C./minute to 80° C., and 1.5° C./minute to 100° C. The sample may be held at 100° C. for 45 minutes, followed by cooling to 40° C. at 2° C./minute, then rinsed and dried to yield the dyed product.

### Method of Forming Fibers and Nonwoven Fabrics

As described herein, the fibers or fabrics of the AM/AV material are made by forming the AM/AV polymer composition into the fibers, which are arranged to form the fabric or structure.

In some aspects, fibers, e.g., polyamide fibers, are made by spinning a polyamide composition formed in a melt polymerization process. During the melt polymerization process of the polyamide composition, an aqueous monomer solution, e.g., salt solution, is heated under controlled conditions of temperature, time and pressure to evaporate water and effect polymerization of the monomers, resulting in a polymer melt. During the melt polymerization process, sufficient amounts of zinc and, optionally, phosphorus, are employed in the aqueous monomer solution to form the polyamide mixture before polymerization. The monomers are selected based on the desired polyamide composition. After zinc and phosphorus are present in the aqueous monomer solution, the polyamide composition may be polymerized. The polymerized polyamide can subsequently be spun into fibers, e.g., by melt, solution, centrifugal, or electro-spinning.

In some embodiments, the process for preparing fibers having permanent AM/AV properties from the polyamide composition includes preparing an aqueous monomer solution, adding less than 20,000 wppm of one or more metallic compounds dispersed within the aqueous monomer solution, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm, polymerizing the aqueous monomer solution to form a polymer melt, and spinning the polymer melt to form an AM/AV fiber. In this embodiment, the polyamide composition comprises the resultant aqueous monomer solution after the metallic compound(s) are added.

In some embodiments, the process includes preparing an aqueous monomer solution. The aqueous monomer solution may comprise amide monomers. In some embodiments, the concentration of monomers in the aqueous monomer solution is less than 60 wt %, e.g., less than 58 wt %, less than 56.5 wt %, less than 55 wt %, less than 50 wt %, less than 45 wt %, less than 40 wt %, less than 35 wt %, or less than 30 wt %. In some embodiments, the concentration of monomers in the aqueous monomer solution is greater than 20 wt %, e.g., greater than 25 wt %, greater than 30 wt %, greater than 35 wt %, greater than 40 wt %, greater than 45 wt %, greater than 50 wt %, greater than 55 wt %, or greater than 58 wt %. In some embodiments, the concentration of monomers in the aqueous monomer solution is in a range from 20 wt % to 60 wt %, e.g., from 25 wt % to 58 wt %, from 30 wt % to 56.5 wt %, from 35 wt % to 55 wt %, from 40 wt % to 50 wt %, or from 45 wt % to 55 wt %. The balance of the aqueous monomer solution may comprise water and/or additional additives. In some embodiments, the monomers comprise amide monomers including a diacid and a diamine, i.e., nylon salt.

In some embodiments, the aqueous monomer solution is a nylon salt solution. The nylon salt solution may be formed by mixing a diamine and a diacid with water. For example, water, diamine, and dicarboxylic acid monomer are mixed to form a salt solution, e.g., mixing adipic acid and hexamethylene diamine with water. In some embodiments, the diacid may be a dicarboxylic acid and may be selected from the group consisting of oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, and muconic acid, 1,2- or 1,3-cyclohexane dicarboxylic acids, 1,2- or 1,3-phenyl enediacetic acids, 1,2- or 1,3-cyclohexane diacetic acids, isophthalic acid, terephthalic acid, 4,4′-oxybisbenzoic acid, 4,4-benzophenone dicarboxylic acid, 2,6-napthalene dicarboxylic acid, p-t-butyl isophthalic acid and 2,5-furandicarboxylic acid, and mixtures thereof. In some embodiments, the diamine may be selected from the group consisting of ethanol diamine, trimethylene diamine, putrescine, cadaverine, hexamethyelene diamine, 2-methyl pentamethylene diamine, heptamethylene diamine, 2-methyl hexamethylene diamine, 3-methyl hexamethylene diamine, 2,2-dimethyl pentamethylene diamine, octamethylene diamine, 2,5-dimethyl hexamethylene diamine, nonamethylene diamine, 2,2,4- and 2,4,4-trimethyl hexamethylene diamines, decamethylene diamine, 5-methylnonane diamine, isophorone diamine, undecamethylene diamine, dodecamethylene diamine, 2,2,7,7-tetramethyl octamethylene diamine, bis(p-aminocyclohexyl)methane, bis(aminomethyl)norbornane, C2-C16 aliphatic diamine optionally substituted with one or more C1 to C4 alkyl groups, aliphatic polyether diamines and furanic diamines, such as 2,5-bis(aminomethyl)furan, and mixtures thereof. In preferred embodiments, the diacid is adipic acid and the diamine is hexamethylene diamine which are polymerized to form PA6,6.

It should be understood that the concept of producing a polyamide from diamines and diacids also encompasses the concept of other suitable monomers, such as, aminoacids or lactams. Without limiting the scope, examples of aminoacids can include 6-aminohaxanoic acid, 7-aminoheptanoic acid, 11-aminoundecanoic acid, 12-aminododecanoic acid, or combinations thereof. Without limiting the scope of the disclosure, examples of lactams can include caprolactam, enantholactam, lauryllactam, or combinations thereof. Suitable feeds for the disclosed process can include mixtures of diamines, diacids, aminoacids and lactams.

After the aqueous monomer solution is prepared, a metallic compound (e.g., a zinc compound, a copper compound, and/or a silver compound) is added to the aqueous monomer solution to form the polyamide composition. In some embodiments, less than 20,000 wppm of the metallic compound is dispersed within the aqueous monomer solution. In some aspects, further additives, e.g., additional AM/AV agents, are added to the aqueous monomer solution. Optionally, phosphorus (e.g., a phosphorus compound) is added to the aqueous monomer solution.

In some cases, the polyamide composition is polymerized using a conventional melt polymerization process. In one aspect, the aqueous monomer solution is heated under controlled conditions of time, temperature, and pressure to evaporate water, effect polymerization of the monomers and provide a polymer melt. In some aspects, the particular weight ratio of zinc to phosphorus may advantageously promote binding of zinc within the polymer, reduce thermal degradation of the polymer, and enhance its dyeability.

In one embodiment, a nylon is prepared by a conventional melt polymerization of a nylon salt. Typically, the nylon salt solution is heated under pressure, e.g. 250 psig/1825×10³ n/m², to a temperature of, for example, about 245° C. Then the water vapor is exhausted off by reducing the pressure to atmospheric pressure while increasing the temperature to, for example, about 270° C. Before polymerization, zinc and, optionally, phosphorus be added to the nylon salt solution. The resulting molten nylon is held at this temperature for a period of time to bring it to equilibrium prior to being extruded into a fiber. In some aspects, the process may be carried out in a batch or continuous process.

In some embodiments, during melt polymerization, zinc, e.g., zinc oxide is added to the aqueous monomer solution. The AM/AV fiber may comprise a polyamide that is made in a melt polymerization process and not in a master batch process. In some aspects, the resulting fiber has permanent AM/AV properties. The resulting fiber can be used in the topsheet layer and/or the pad layer of the AM/AV material.

The AM/AV agent may be added to the polyamide during melt polymerization, for example as a master batch or as a powder added to the polyamide pellets, and thereafter, the fiber may be formed from spinning. The fibers can then be formed into a nonwoven structure.

In some aspects, the AM/AV nonwoven structure is melt blown. Melt blowing is advantageously less expensive than electrospinning. Melt blowing is a process type developed for the formation of microfibers and nonwoven webs. Until recently, microfibers have been produced by melt blowing. Now, nanofibers may also be formed by melt blowing. The nanofibers are formed by extruding a molten thermoplastic polymeric material, or polyamide, through a plurality of small holes. The resulting molten threads or filaments pass into converging high velocity gas streams which attenuate or draw the filaments of molten polyamide to reduce their diameters. Thereafter, the melt blown nanofibers are carried by the high velocity gas stream and deposited on a collecting surface, or forming wire, to form a nonwoven web of randomly disbursed melt blown nanofibers. The formation of nanofibers and nonwoven webs by melt blowing is well known in the art. See, e.g., U.S. Pat. Nos. 3,704,198; 3,755,527; 3,849,241; 3,978,185; 4,100,324; and 4,663,220.

One option, “Island-in-the-sea,” refers to fibers forming by extruding at least two polymer components from one spinning die, also referred to as conjugate spinning.

As is well known, electrospinning has many fabrication parameters that may limit spinning certain materials. These parameters include: electrical charge of the spinning material and the spinning material solution; solution delivery (often a stream of material ejected from a syringe); charge at the jet; electrical discharge of the fibrous membrane at the collector; external forces from the electrical field on the spinning jet; density of expelled jet; and (high) voltage of the electrodes and geometry of the collector. In contrast, the aforementioned nanofibers and products are advantageously formed without the use of an applied electrical field as the primary expulsion force, as is required in an electrospinning process. Thus, the polyamide is not electrically charged, nor are any components of the spinning process. Importantly, the dangerous high voltage necessary in electrospinning processes, is not required with the presently disclosed processes/products. In some embodiments, the process is a non-electrospin process and resultant product is a non-electrospun product that is produced via a non-electrospin process.

Another embodiment of making the nanofiber nonwovens is by way of 2-phase spinning or melt blowing with propellant gas through a spinning channel as is described generally in U.S. Pat. No. 8,668,854. This process includes two phase flow of polymer or polymer solution and a pressurized propellant gas (typically air) to a thin, preferably converging channel. The channel is usually and preferably annular in configuration. It is believed that the polymer is sheared by gas flow within the thin, preferably converging channel, creating polymeric film layers on both sides of the channel. These polymeric film layers are further sheared into nanofibers by the propellant gas flow. Here again, a moving collector belt may be used and the basis weight of the nanofiber nonwoven is controlled by regulating the speed of the belt. The distance of the collector may also be used to control fineness of the nanofiber nonwoven.

Beneficially, the use of the aforementioned polyamide precursor in the melt spinning process provides for significant benefits in production rate, e.g., at least 5% greater, at least 10% greater, at least 20% greater, at least 30% greater, at least 40% greater. The improvements may be observed as an improvement in area per hour versus a conventional process, e.g., another process that does not employ the features described herein. In some cases, the production increase over a consistent period of time is improved. For example, over a given time period, e.g., one hour, of production, the disclosed process produces at least 5% more product than a conventional process or an electrospin process, e.g., at least 10% more, at least 20% more, at least 30% more, or at least 40% more.

Still yet another methodology which may be employed is melt blowing. Melt blowing involves extruding the polyamide into a relatively high velocity, typically hot, gas stream. To produce suitable nanofibers, careful selection of the orifice and capillary geometry as well as the temperature is required as is seen in: Hassan et al., J Membrane Sci., 427, 336-344, 2013 and Ellison et al., Polymer, 48 (11), 3306-3316, 2007, and, International Nonwoven Journal, Summer 2003, pg 21-28.

U.S. Pat. No. 7,300,272 (incorporated herein by reference) discloses a fiber extrusion pack for extruding molten material to form an array of nanofibers that includes a number of split distribution plates arranged in a stack such that each split distribution plate forms a layer within the fiber extrusion pack, and features on the split distribution plates form a distribution network that delivers the molten material to orifices in the fiber extrusion pack. Each of the split distribution plates includes a set of plate segments with a gap disposed between adjacent plate segments. Adjacent edges of the plate segments are shaped to form reservoirs along the gap, and sealing plugs are disposed in the reservoirs to prevent the molten material from leaking from the gaps. The sealing plugs can be formed by the molten material that leaks into the gap and collects and solidifies in the reservoirs or by placing a plugging material in the reservoirs at pack assembly. This pack can be used to make nanofibers with a melt blowing system described in the patents previously mentioned. The systems and method of U.S. Pat. No. 10,041,188 (incorporated herein by reference) are also exemplary.

In one embodiment, a process for preparing the AM/AV nonwoven polyamide structure, e.g., for use in the fabric sheet, is disclosed. The process comprising the step of forming a (precursor) polyamide (preparation of monomer solutions is well known), e.g., by preparing an aqueous monomer solution. During preparation of the precursor, a metallic compound, such as zinc, is added (as discussed herein). In some cases, the metallic compound is added to (and dispersed in) the aqueous monomer solution. Phosphorus may also be added. In some cases, the precursor is polymerized to form a polyamide composition. The process further comprises the steps of forming polyamide fibers and forming the AM/AV polyamide fibers into a structure. In some cases, the polyamide composition is melt spun, spunlaced, spunbonded, electrospun, solution spun, or centrifugally spun. The resulting fibers can be melt spun fibers, spunlace fiber, sponbond fibers, electrospun fibers, solution spun fibers, centrifugal spun fibers, or staple fibers.

A fabric can be made from the fibers by conventional means.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

In some embodiments, any or some of the components or steps disclosed herein may be considered optional. In some cases, the disclosed compositions may expressly exclude any or some of the aforementioned components or steps in this description, e.g., via claim language. For example, claim language may be modified to recite that the disclosed compositions, materials processes, etc., do not utilize or comprise one or more of the aforementioned additives, e.g., the disclosed materials do not comprise a flame retardant or a delusterant. As another example, the claim language may be modified to recite that the disclosed materials do not comprise long chain polyamide component, e.g., PA-12. Such negative limitations are contemplated, and this text serves as support for negative limitations for components, steps, and/or features.

### EXAMPLES

Nylon/cotton fiber or yarn blends (also commonly known as NYCO blends) were prepared using cotton staples and/or polyamide staples. The polyamide staples were formed by the typical staple production process, e.g., melt extrusion, filament formation, drawing, crimping and cutting. The formic acid relative viscosity of the fibers/staples ranged from 20 to 60, e.g., from 30 to 50. The base polyamide staples of working Examples were produced using an AM/AV polymer composition comprising PA-66 and various amount of zinc ranging from 100 wppm to 400 wppm. The base fibers/fabrics of the Comparative Examples comprised only polymer and did not comprise zinc.

The fabrics were treated with a 25% sodium hydroxide solution for approximately 1 minute. The treatment was conducted at a temperature of approximately 15° C.

The fabrics were tested for AM/AV efficacy as measured by Staph Aureus and Klebsiella pneumonia log reduction (as determined via ISO20743:2013).

The compositions of the Example and Comparative Examples, along with the results, are shown in Table 1 below.

TABLE 1
Test Results

| | | | | Zn in | | | |
|---|---|---|---|---|---|---|---|
| | | | | Fabric | | Log | Log |
| | Sample | Nylon | Cotton | Blend | Sample | Reduction | Reduction |
| | Number | % | % | (ppm) | Mercerized | Staph | Klebsiella |
| Nylon/Cotton | Comp. | 0 | 100 | 53 | No | 0.6 | 0.7 |
| Blend Series | Ex. A | | | | | | |
| A | Comp. | 100 | 0 | 452 | No | 3.0 | 2.7 |
| | Ex. B | | | | | | |
| | Ex 1 | 60 | 40 | 296 | Yes | 4.8 | 4.0 |
| Nylon/Cotton | Comp. | 0 | 100 | 68 | No | 0.1 | 0.0 |
| Blend Series | Ex. C | | | | | | |
| B | Comp. | 100 | 0 | 475 | No | 1.5 | 3.7 |
| | Ex. D | | | | | | |
| | Ex 2 | 60 | 40 | 307 | Yes | 5.9 | 8.2 |
| Nylon/Cotton | Comp. | 100 | 0 | 519 | No | 2.2 | 2.0 |
| Blend Series | Ex. E | | | | | | |
| C | Ex 3 | 90 | 10 | 224 | Yes | 7.8 | 7.4 |
| | Ex 4 | 80 | 20 | 349 | Yes | 3.4 | 7.4 |
| | Ex 5 | 50 | 50 | 137 | Yes | 5.0 | 8.2 |
| | Ex 6 | 40 | 60 | 195 | Yes | 4.1 | 7.4 |
| | Ex 7 | 20 | 80 | 111 | Yes | 6.2 | 5.8 |
| Nylon/Cotton | Comp. | 0 | 100 | 0 | No | 0.2 | 0.0 |
| Blend Series | Ex. F | | | | | | |
| D | Comp. | 40 | 60 | 0 | No | 0.0 | 0.1 |
| | Ex. G | | | | | | |
| | Comp. | 60 | 40 | 0 | No | 0.0 | 0.0 |
| | Ex. H | | | | | | |
| | Comp. | 100 | 0 | 0 | No | 0.3 | 0.8 |
| | Ex. I | | | | | | |
| Nylon/Cotton | Ex 8 | 57 | 43 | 260 | Yes | 7.1 | 7.5 |
| Blend Series | | | | | | | |
| E | | | | | | | |

As shown in Table 1, the alkali-treated (zinc-containing) working Examples demonstrated superior performance in both Klebsiella pneumonia and Staph Aureus log reduction over the untreated Comparative examples. These examples demonstrate surprising and synergistic results achieved by the disclosed treatment of base fabric/fibers (comprising an AM/AV compound) with an alkali composition.

For example, Exs. 1 and 2 each employed a 60/40 nylon/cotton blend and were treated with the alkali solution. Ex. 8 employed a similar 57/43 nylon cotton blend and was treated with the alkali solution. Comp. Ex. H also employed a 60/40 nylon/cotton blend, but had no zinc content and was not treated with the alkali solution. Exs. 1, 2, and 8 surprisingly demonstrated Staph log reductions of 4.8, 5.9, and 7.1, respectively, while Comp. Ex. H demonstrated a Staph log reduction of 0, under the same test conditions. Exs. 1, 2, and 8 surprisingly demonstrated Klebsiella log reductions of 4.0, 8.2, and 7.5, respectively, while Comp. Ex. H demonstrated a Klebsiella log reduction of 0, under the same test conditions.

Also, Ex. 6 employed a 40/60 nylon/cotton blend and was treated with the alkali solution. Ex. G also employed a 40/60 nylon/cotton blend, but had no zinc content and was not treated with the alkali solution. Ex. 6 surprisingly demonstrated a Staph log reduction of 4.1, while Comp. Ex. G demonstrated a Staph log reduction of 0, under the same test conditions. Ex. 6 surprisingly demonstrated a Klebsiella log reduction of 7.4, while Comp. Ex. G demonstrated a Klebsiella log reduction of 0.1, under the same test conditions.

Ex. 3 employed a nylon-heavy blend (90/10) with 224 ppm zinc and was treated with the alkali solution. Comp. Ex. E employes a similar blend (all nylon) and a higher zinc content (519) and was not treated with the alkali solution. Even though zinc content was lower, Ex. 3 unexpectedly demonstrated a Staph log reduction of 7.8, while Comp. Ex. E demonstrated a Staph log reduction of only 2.2, under the same test conditions. And Ex. 3 unexpectedly demonstrated a Klebsiella log reduction of 7.4, while Comp. Ex. E demonstrated a Klebsiella log reduction of only 2.0, under the same test conditions. These results are particularly unexpected because Ex. 3 employed a lower zinc content.

The examples are replete with additional surprising comparisons that demonstrate the synergistic benefits of the disclosed process and resultant AM/AV fibers.

### EMBODIMENTS

As used below, any reference to a series of embodiments is to be understood as a reference to each of those embodiments disjunctively (e.g., “Embodiments 1-4” is to be understood as “Embodiments 1, 2, 3, or 4”).

Embodiment 1 is a process for producing improved, treated AM/AV fibers comprising treating, with an alkali composition, base fibers, e.g., base AM/AV fibers, comprising a polymer composition comprising a polymer and an AM/AV compound to form the improved, treated AM/AV fibers, wherein the improved, treated AM/AV fibers demonstrate a Klebsiella pneumonia log reduction greater than 1.5, as determined via ISO20743:2013.

Embodiment 2 is the process of embodiment 1, wherein the polymer, e.g., of the base AM/AV fibers, comprises a polyamide.

Embodiment 3 is the process of embodiment 1 or 2, wherein the treating comprises treating base AM/AV fibers to form the treated AM/AV fibers and treating the companion fibers to form treated companion fibers and wherein the companion fibers comprise a natural fiber, preferably cotton and/or cellulose.

Embodiment 4 is a process of embodiments 1-3, wherein the polymer of the AM/AV fibers comprises polyamide and polymer of the companion fibers comprises cellulose and/or cotton.

Embodiment 5 is a process of embodiments 1-4, wherein the mercerizing improves the AM/AV performance of the fibers versus that of the base fibers.

Embodiment 6 is a process of embodiments 1-5, wherein the polymer composition comprises from 5 wppm to 20,000 wppm AM/AV compound.

Embodiment 7 is a process of embodiments 1-6, wherein the improved, treated AM/AV fibers demonstrate an Escherichia coli log reduction greater than 1.5, as determined via ASTM E3160 (2018).

Embodiment 8 is a process of embodiments 1-7, wherein the improved, treated AM/AV fibers demonstrate a Staph Aureus log reduction greater than 3.0, as determined via ISO20743:2013

Embodiment 9 is a process of embodiments 1-8, wherein the polymer composition has a relative viscosity less than 100, as measured by the formic acid method.

Embodiment 10 is a process of embodiments 1-9, wherein the polymer, e.g., of the base AM/AV fibers, is hydrophilic and/or hygroscopic, and is capable of absorbing greater than 1.5 wt % water, based on the total weight of the polymer.

Embodiment 11 is a process of embodiments 1-10, wherein the polymer, e.g., of the base AM/AV fibers, comprises PA6, PA 6,6, PA 6,10, or PA 6,12, or combinations thereof.

Embodiment 12 is a process of embodiments 1-11, wherein the treatment comprises contacting the base AM/AV fibers with an alkali solution with a concentration ranging from 5% to 50%.

Embodiment 13 is a process of embodiments 1-12, wherein the treatment is conducted at a dwell time ranging from 5 seconds to 30 minutes.

Embodiment 14 is a process of embodiments 1-13, wherein the treatment is conducted at a temperature ranging from 5° C. to 50° C.

Embodiment 15 is a process of embodiments 1-14, further comprising the steps of washing and/or neutralizing the fibers.

Embodiment 16 is a process of embodiments 1-15, wherein the fibers comprises a polyamide polymer matrix embedded with ionic zinc (Zn²⁺).

Embodiment 17 is a process of embodiments 1-6, wherein the AM/AV base fibers comprise staple fibers.

Embodiment 18 is treated AM/AV fibers comprising a polymer and an AM/AV compound, wherein the treated AM/AV fibers are alkali-treated with an alkali composition, wherein the AM/AV fibers demonstrate a Klebsiella pneumonia log reduction greater than 1.5, as determined via ISO20743:2013.

Embodiment 19 is the fibers of embodiment 18, wherein the alkali composition has a concentration ranging from 5% to 50%.

Embodiment 20 is the fibers of embodiment 18 or 19, wherein the treated AM/AV fibers comprise PA6, PA 6,6, PA 6,10, or PA 6,12, or combinations thereof and wherein the treated AM/AV fibers have a relative viscosity ranging from 20 to 60, as measured by the formic acid method.

We claim:

1. A process for producing treated AM/AV fibers comprising:
treating, with an alkali composition, base AM/AV fibers comprising a polymer composition comprising a polymer and an AM/AV compound to form treated AM/AV fibers;
wherein the treated AM/AV fibers demonstrate a Klebsiella pneumonia log reduction greater than 1.5, as determined via ISO20743:2013.

2. The process of claim 1, wherein the polymer of the base AM/AV fibers comprises a polyamide.

3. The process of claim 1, wherein the treating comprises treating base AM/AV fibers to form the treated AM/AV fibers and treating companion fibers to form treated companion fibers.

4. The process of claim 3, wherein the companion fibers comprise a natural fiber.

5. The process of claim 3, wherein the polymer of the base AM/AV fibers comprises polyamide and polymer of the companion fibers comprises cellulose and/or cotton.

6. The process of claim 1, wherein the polymer composition comprises from 5 wppm to 20,000 wppm AM/AV compound.

7. The process of claim 1, wherein the treated AM/AV fibers demonstrate an Escherichia coli log reduction greater than 1.5, as determined via ASTM E3160 (2018).

8. The process of claim 1, wherein the treated AM/AV fibers demonstrate a Staph Aureus log reduction greater than 3.0, as determined via ISO20743:2013

9. The process of claim 1, wherein the polymer composition has a relative viscosity less than 100 as measured by the formic acid method.

10. The process of claim 1, wherein the polymer of the base AM/AV fibers is hydrophilic and/or hygroscopic, and is capable of absorbing greater than 1.5 wt % water, based on the total weight of the polymer.

11. The process of claim 1, wherein the polymer of the base AM/AV fibers comprises PA6, PA 6,6, PA 6,10, or PA 6,12, or combinations thereof.

12. The process of claim 1, wherein the treatment comprises contacting the base AM/AV fibers with an alkali composition having a concentration ranging from 5% to 50%.

13. The process of claim 1, wherein the treatment is conducted at a dwell time ranging from 5 seconds to 30 minutes.

14. The process of claim 1, wherein the treatment is conducted at a temperature ranging from 5° C. to 50° C.

15. The process of claim 1, further comprising the steps of washing the treated fibers and neutralizing the fibers.

16. The process of claim 1, wherein the fibers comprise a polyamide polymer matrix embedded with ionic zinc (Zn²⁺).

17. The process of claim 1, wherein the AM/AV base fibers comprise staple fibers.

18. Treated AM/AV fibers comprising a polymer and an AM/AV compound, wherein the treated AM/AV fibers are alkali-treated with an alkali composition, wherein the AM/AV fibers demonstrate a Klebsiella pneumonia log reduction greater than 1.5, as determined via ISO20743:2013.

19. The treated AM/AV fibers of claim 18, wherein the alkali composition has a concentration ranging from 5% to 50%.

20. The treated AM/AV fibers of claim 18, wherein the treated AM/AV fibers comprise PA6, PA 6,6, PA 6,10, or PA 6,12, or combinations thereof and wherein the treated AM/AV fibers have a relative viscosity ranging from 20 to 60, as measured by the formic acid method.
